(19) United States
(12) Patent Application Publication
(10) Pub. No.: US 2025/0358305 A1
(43) Pub. Date: Nov. 20, 2025

(54) Gamification of Security Program And Engineer Work Product

(71) Applicants: Jeremy J. Vaughan, Jacksonville Beach, FL (US); Joseph M. Procopio, Jacksonville, FL (US); Daniel DiLallo, St. Augustine, FL (US); Joseph Walchuck, Myersville, MD (US); Mauricio A. Cabrales, Sabaneta (CO)

(72) Inventors: Jeremy J. Vaughan, Jacksonville Beach, FL (US); Joseph M. Procopio, Jacksonville, FL (US); Daniel DiLallo, St. Augustine, FL (US); Joseph Walchuck, Myersville, MD (US); Mauricio A. Cabrales, Sabaneta (CO)

(73) Assignee: Tauruseer, Inc., Jacksonville, FL (US)

(21) Appl. No.: 18/755,019

(22) Filed: Jun. 26, 2024

Related U.S. Application Data
(60) Provisional application No. 63/649,362, filed on May 18, 2024.

(51) Int. Cl. H04L 9/40

(52) U.S. Cl. CPC H04L 63/1433

(57) ABSTRACT

The present disclosure provides a system for the gamification of developer work product based on cybersecurity parameters. The system may include a risk assessment platform that may be configured to receive and evaluate developer work product, wherein the developer may be assigned digital points that may be translated into certain rewards. The rewards may include badges and achievements that may be displayed on a graphical user interface including a developer profile. A method for gamifying cybersecurity may include the accessing of developer work product, wherein the developer work product evaluates the developer work product for risks and vulnerabilities. The method may include assigning digital points where the digital points may translate into rewards, wherein the rewards may include badges and achievements.

### CROSS-REFERENCE TO RELATED APPLICATION

This application claims priority to and the full benefit of U.S. Provisional Patent Application Ser. No. 63/649,362 (filed May 18, 2024, and titled “GAMIFICATION OF DEVELOPER WORK PRODUCT”), the entire contents of which are incorporated in this application by reference.

### BACKGROUND

Gamification is the use of certain game elements and design in environments that typically do not involve them to further objectives while simultaneously stimulating user engagement and motivation. Originally, gamification grew out of platforms and systems adjacent to the video game industry. Game systems like Microsoft's Xbox created game mechanics on their websites to encourage their users to engage with its contents that included score systems and rewards. In recent years, the gamification of activities and systems has been implemented among a variety of industries to motivate and engage users.

Implementing game systems into new environments has been successful in encouraging participation and healthy competition. The practice has been typically used by businesses for their consumers. Businesses and organizations develop and integrate software with gamification capabilities to work alongside their normal operation. Some of these implementations of gamification include creating a roleplay environment in which working through the standard processes may involve experiencing a story. Other implementations may involve the collection of rewards or achievements for the successful completion of objectives.

Organizations increasingly integrate gamification into their products as it gives users additional goals or reasons to maintain activity or complete certain objectives. As gamification's benefits continue to prove themselves, it has continued to expand its application. Nowadays, businesses and organizations have begun to implement gamification into their own workflow. The goal is that their employees may find additional motivation in their position in their desire to interact with these game elements.

In this expansion of gamification into the workplace, there are certain industries that have not yet caught up. Specifically, in the software and security industry, there are not any iterations of gamification setup to improve and encourage workflow. If a way to gamify software security existed, it may provide a significant motivating factor and improvement to the overall company product. As developers interact with the game systems, they may also improve their own capabilities whilst contributing their improved ability to their company or future company. What is needed is a platform that may gamify developer software to encourage engagement and motivation.

### SUMMARY OF THE DISCLOSURE

What is needed is a system of gamifying cybersecurity to encourage and motivate developers to reduce vulnerabilities in developer work product. In some embodiments, a system for gamifying cybersecurity may include a risk assessment platform. In some aspects, the risk assessment platform may be configured to receive at least a portion of developer work product associated with a developer profile, wherein the portion of developer work product originates from at least a first developer. In some implementations, the risk assessment platform may evaluate at least a portion of developer work product, wherein evaluating assesses a first vulnerability factor based on whether the at least the portion of the developer work product increases vulnerability or decreases vulnerability of at least a first product. In some aspects, the risk assessment platform may assign at least one set of digital points to the developer profile based on the assessment.

In some embodiments, a method for risk assessment for a risk assessment platform for gamifying cybersecurity is disclosed. In some aspects, the method may include assessing at least a portion of developer work product, wherein the assessed at least portion of developer work product is evaluated for risks and vulnerabilities. In some implementations, the at least a portion of evaluated developer work product may be translated onto a developer profile. In some aspects, the method may include assigning digital points based on the at least a portion of evaluated work product. In some implementations, the risk assessment platform may reward digital badges, blockchain, non-fungible tokens (NFTs), and achievements based on the assigned digital points.

A number of embodiments of the present disclosure will be described. While this specification contains many specific implementation details, these should not be construed as limitations on the scope of any disclosures or of what may be claimed, but rather as descriptions of features specific to particular embodiments of the present disclosure. It is understood to those skilled in the art that variations, modifications, and alterations may be apparent. It will be understood that various modifications may be made without departing from the spirit and scope of the disclosure.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates an exemplary system for the gamification of cybersecurity, according to some embodiments of the present disclosure.

FIG. 2 illustrates a developer profile interface of a gamification system, according to some embodiments of the present disclosure, according to some embodiments of the present disclosure.

FIG. 3 illustrates a developer profile interface of a gamification system, according to some embodiments of the present disclosure.

FIG. 4 illustrates a developer profile interface of a gamification system, according to some embodiments of the present disclosure.

FIG. 5 illustrates a developer profile interface of a gamification system, according to some embodiments of the present disclosure.

FIG. 6 illustrates a developer profile interface of a gamification system, according to some embodiments of the present disclosure.

FIG. 7 illustrates a team profile interface of a gamification system, according to some embodiments of the present disclosure.

FIG. 8 illustrates an enterprise profile interface of a gamification system, according to some embodiments of the present disclosure.

FIG. 9 illustrates an enterprise profile interface of a gamification system, according to some embodiments of the present disclosure.

FIG. 10 illustrates an enterprise profile interface of a gamification system, according to some embodiments of the present disclosure.

FIG. 11 illustrates an enterprise profile interface of a gamification system, according to some embodiments of the present disclosure.

FIG. 12 illustrates an enterprise profile interface of a gamification system, according to some embodiments of the present disclosure.

FIG. 13 illustrates a profile transfer of a gamification system, according to some embodiments of the present disclosure.

FIG. 14 illustrates a method for the implementation of development tools of a gamification system, according to some embodiments of the present disclosure.

FIG. 15 illustrates a method for a gamification system of cybersecurity, according to some embodiments of the present disclosure.

FIG. 16 illustrates a method for a graphical user interface for a gamification system of cybersecurity, according to some embodiments of the present disclosure.

The Figures are not necessarily drawn to scale, as their dimensions can be varied considerably without departing from the scope of the present disclosure.

### DETAILED DESCRIPTION

The present disclosure provides generally for a system for gamifying cybersecurity. According to the present disclosure, the gamification of cybersecurity may encourage engagement and motivation in reducing vulnerabilities in developer work product.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Developer: as used herein refers to any individual that uses the gamification system, wherein the individual contributes code or programming that may be evaluated by the risk assessment platform and assigned to a developer profile.
Developer Work Product: as used herein refers to any code and programming that is produced by a developer while they are using developer tools within a platform that is monitored by a risk assessment platform, wherein the risk assessment platform is actively monitoring the developer work product for vulnerabilities.
Digital points: as used herein refers to the objective values assigned to a developer based on their developer work product, tasks completed, and educational courses completed, wherein the digital point may be distributed as rewards to indicate a developer's skill level, progression, and associated risk levels of their developer work product.
Vulnerability: as used herein refers to any weakness, risk, or digital point of improvement identified in developer work product, wherein the existence of the weakness, risk, or point of improvement is related to safety, security, or cybersecurity. Vulnerability may include risks associated with cyber security, financial security, threats, processes, and people, as non-limiting examples.
Risk Assessment Platform: as used herein refers to the functionality of the gamification system that analyzes developer work product, identifies risks and vulnerabilities, assigns digital points to the developer, and transfers the acquired data to a cloud-based application.

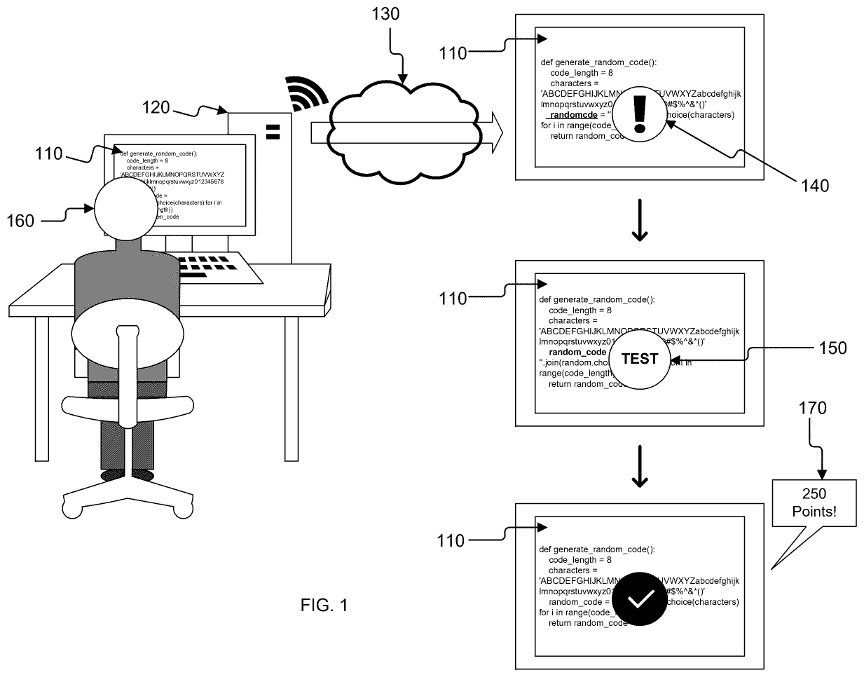

Referring now to FIG. 1, an exemplary system for the gamification of cybersecurity, according to some embodiments of the present disclosure, is illustrated. In some embodiments, the system for the gamification of cybersecurity may include a developer work product 110, a developer computing device 120, and a risk assessment platform 130. In some implementations, the developer computing device 120 may be configured to send data through the Internet 140 and/or private network, wherein the developer work product 110 may be received by a cloud-based application. In some embodiments, the risk assessment platform 130 may be utilized by the cloud-based application, wherein the data received from developer and enterprise use of the risk assessment platform may be transferred to the cloud-based application.

In some embodiments, the risk assessment platform may be configured to provide real time evaluation of developer work product, wherein vulnerabilities 140 assessed by the risk assessment platform 130 may be identified. In some aspects, the developer 160 may test solutions to the identified vulnerabilities. In some implementations, the risk assessment platform 130 may indicate whether the tested solutions resolved the identified vulnerabilities 140.

In some aspects, the risk assessment platform 130 may be configured to run a test 150 to evaluate the entirety of a developer work product 110 or of an enterprise code or programming associated with a developer tool or product, wherein the risk assessment platform 130 may be used retroactively to determine risks and vulnerabilities 140. In some embodiments, the risk assessment platform 130 may be configured to evaluate the developer work product 110 for vulnerabilities 140 and other issues. By way of example and not limitation, other issues that may be evaluated by the risk assessment platform 130 may include financial risks, coding accuracy, cybersecurity recommendations, security threats, process risks, stylistic recommendations, and typographical corrections. In some implementations, the risk assessment platform 130 may be integrated into an organization's code or programming at any stage of its development.

In some embodiments, the risk assessment platform 130 may be configured to operate on a schedule, wherein a developer 160, team, or organization may be able to manually determine when the analysis of developer work product 110 may be conducted. In some implementations, the risk assessment platform 130 may be configured to provide recommendations and improvements to developer work product. In some aspects, the developer work product may be into a digital point 170 score based on the vulnerabilities identified by the risk assessment platform 130, wherein the cloud-based application may include a developer profile that continually tracks the information obtained by the risk assessment platform 130. In some aspects, the digital point 170 may be distributed based on a user's development, a user's avoidance of risk, a user's closure of an identified vulnerability, and the speed at which a user resolves an identified vulnerability, as non-limiting examples.

In some embodiments, the risk assessment platform 130 may include developer tools to assist in the development of the developer work product 110. In some aspects, the developer tools may integrate, augment, replace, or any developer tools that the developer 160 uses outside of the risk assessment platform 130. In some implementations, an enterprise, team, or a developer 160 may be able to choose from a variety of developer tools located on the cloud-based application's user interface, wherein the developer tool's may be integrated into the risk assessment platform 130. In some aspects, the developer tools may be configured to create, test, suggest, evaluate, and debug code or programming, as non-limiting examples.

In some aspects, an enterprise or team may be able to rank the strength of their developers 160 based on the score of their developer work product 110, wherein the risk assessment platform 130 maybe configured to assign more digital points 170, badges, blockchain, non-fungible tokens (NFTs), and rewards to developers with more digital points 170. In some embodiments, the cloud-based application may be configured to manually assign developers tasks or educational materials, wherein the completion of the tasks or educational materials may accumulate digital points 170.

In some aspects, an enterprise or team may assign tasks or educational materials to their developers 160, wherein an enterprise or team may be able to ascertain the strengths and weaknesses of their developer 160 based on analysis provided by the risk assessment platform 130. In some implementations, the risk assessment platform 130 may provide recommendations as to what tasks or educational materials are most appropriate for a developer, team, or enterprise. In some embodiments, the completion of the tasks or educational materials by a developer 160 may prompt the risk assessment platform 130 to assign additional digital points 170. In some implementations, the risk assessment platform may be scheduled to analyze the entire code or programming of an enterprise, team, or developer, wherein the risk assessment platform 130 may identify risks and vulnerabilities 140. In some aspects, the risk assessment platform 130 may be configured to analyze code at certain trigger digital points 170 in an organization, team, or developers 160 work schedule.

In some embodiments, the risk assessment platform 130 may include artificial intelligence (AI). In some aspects, the risk assessment platform 130 may train AI infrastructures to evaluate and assess developer work product 110, wherein the AI infrastructure may learn as it operates, learning to improve the AI infrastructures ability to identify risks or vulnerabilities 140 in the developer work product 110. In some embodiments, the AI infrastructures may be configured to determine the digital points 170 assigned to a developer 160 based on the developer's code. In some aspects, the AI infrastructure may be trained to assist in the distribution of rewards, badges, and digital points 170, as non-limiting examples.

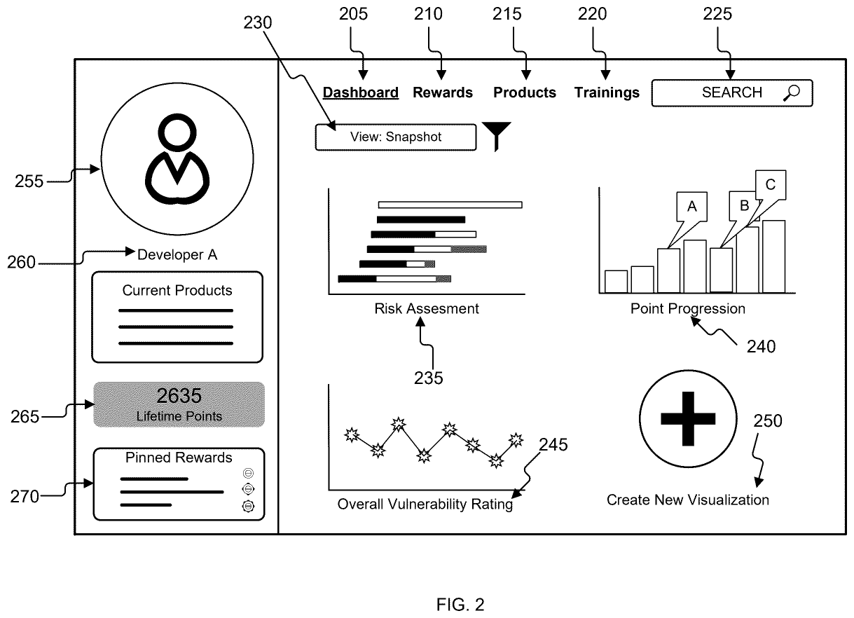

Referring now to FIG. 2, a developer profile interface of a gamification system, according to some embodiments of the present disclosure, is illustrated. In some embodiments, a developer profile interface 200 may be configured to receive information from a risk assessment platform, wherein the risk assessment platform may evaluate a developer work product. In some implementations, the data received by the risk assessment platform may be assigned to a developer profile, wherein the developer profile may include a developer profile interface 200 that may be interacted with. In some embodiments, the developer profile interface may include a menu. In some embodiments, the menu includes a dashboard tab 205, a rewards tab 210, a products tab 215, a trainings tab 220, and a search feature 225, wherein clicking a tab on the menu may be configured to direct a user to a separate page, wherein different information may be displayed.

In some aspects, the dashboard tab 205 may include at least one view of the developer profile, wherein the dashboard tab may provide an overview of the developer's status. In some embodiments, a snapshot view 230 of the developer's profile may include graphics and information on risk assessment 235, point progression 240, and overall performance rating 245, as non-limiting examples.

In some implementations, the risk assessment 235 may be configured to show an overview of the developer's identified vulnerabilities. In some aspects, the point progression 240 may be configured to show the point accumulation of a developer over time. In some implementations, the overall performance rating 245 may rate the average of the developer work product based on its vulnerabilities or resolution of vulnerabilities. Each event may be tracked and monitored, which may allow for more accurate understanding of the skill level of the developer. In some embodiments, the dashboard tab 205 may include an option to create new visualization 250, wherein a developer may customize and create a graphic display based on the data it received from developer work product. A developer may adjust the developer profile interface to move around the different displays to suit their preferred arrangement.

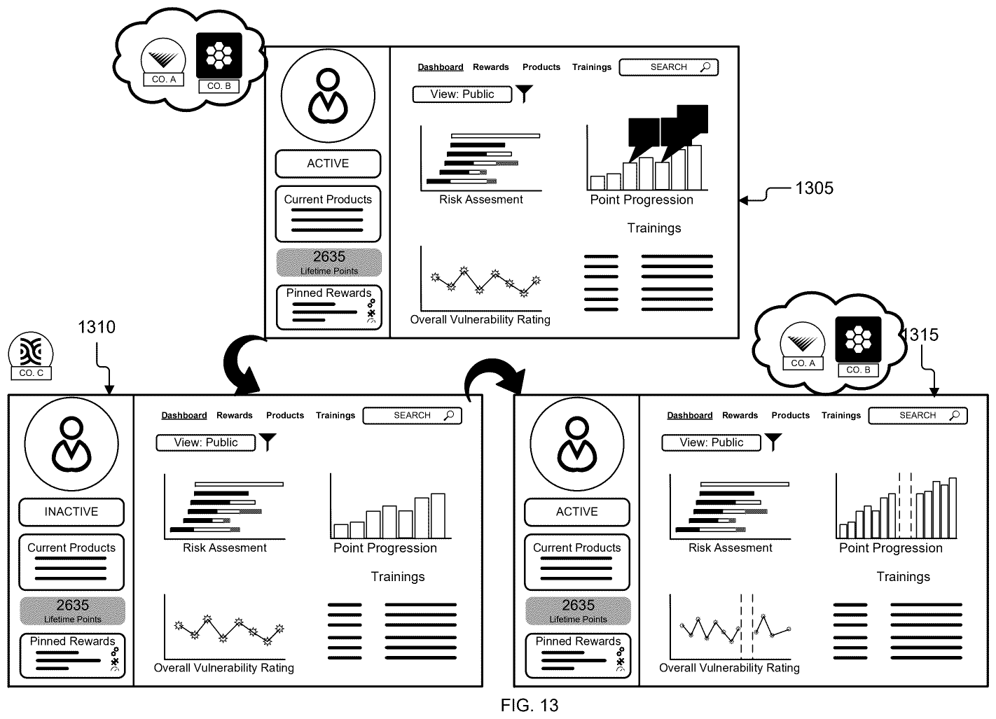

In some aspects, the point progression 240 may indicate actions or activities that caused a spike or decrease in points. As a non-limiting example, at A, Developer A may have taken a course or earned a badge; at B, Developer A may have failed to update their programming for an extended period of time, causing a vulnerability; and at C, Developer A may have responded to a vulnerability notice quickly and took a course to reduce the chance of repeating that error. In some implementations, the spikes or decreases may be explicitly identifiable, based on proprietary information, such as project, product, vulnerability, developer tool, team, or impact on enterprise. In public view, such as illustrated in FIG. 13, these events may be redacted to protect the confidential information while still tracking point progression 240.

In some embodiments, a developer profile interface may be configured to display a picture of the developer 255, the developers name 260, the digital point total 265, and pinned rewards 270. In some aspects, the picture of the developer 255 may be uploaded into developer's profile. In some implementations, the digital point total 265 may include all of the digital points that the developer received while using the risk assessment platform. In some embodiments, the pinned rewards 270 may include a plurality of badges or achievements, wherein the plurality of badges or achievements are selected among the badges or achievements the developer earned or is striving to earn throughout their engagement with the risk assessment platform. In some implementations, the pinned rewards 270 may be configured to allow the developer to choose which badges and achievements they'd like to display among the badges and achievements they have earned through their engagement with the risk assessment platform.

In some embodiments, the gamification system may include a social media infrastructure. In some aspects, a graphical user interface of the gamification system may include a menu interface, wherein the menu interface appears on the developer profile, a team profile, and an enterprise profile, as non-limiting examples. In some implementations, a user may navigate between different developer profiles on the social media infrastructure. In some embodiments, users may be able to communicate and connect on the social media infrastructure.

In some embodiments, the picture of the developer 255 may include an avatar. In some aspects, the avatar may be a customizable design or photograph, wherein the customizable design or photograph may be selected from a variety of predetermined options or may be manually uploaded onto the graphical user interface. In some implementations, the avatar may be used to identify a user, wherein the avatar may be displayed to others based on the activity of the user. In some embodiments, the developer's performance rating may be associated with their avatar.

In some embodiments, the developer profile interface 200 may include a talent marketplace. In some implementations, the talent marketplace may be accessible from the team profile interface and the enterprise profile interface. In some aspects, the talent marketplace may provide a social network configured for job listings, wherein a user may search for job opportunities using the talent marketplace and an enterprise may list job openings on the talent marketplace for users to apply, as non-limiting examples. In some embodiments, the talent marketplace may emphasize the performance rating of a user, wherein the digital points, badges, blockchain, non-fungible tokens (NFTs), and achievements may be displayed upon application to a job opportunity. In some aspects, the talent marketplace may include a subscription, wherein users may access exclusive job opportunities that may prioritize their application based on their activity on the risk assessment platform. By way of example and not limitation, the user may receive digital certifications based on their developer work product, wherein the user may share their digital certifications with potential enterprises.

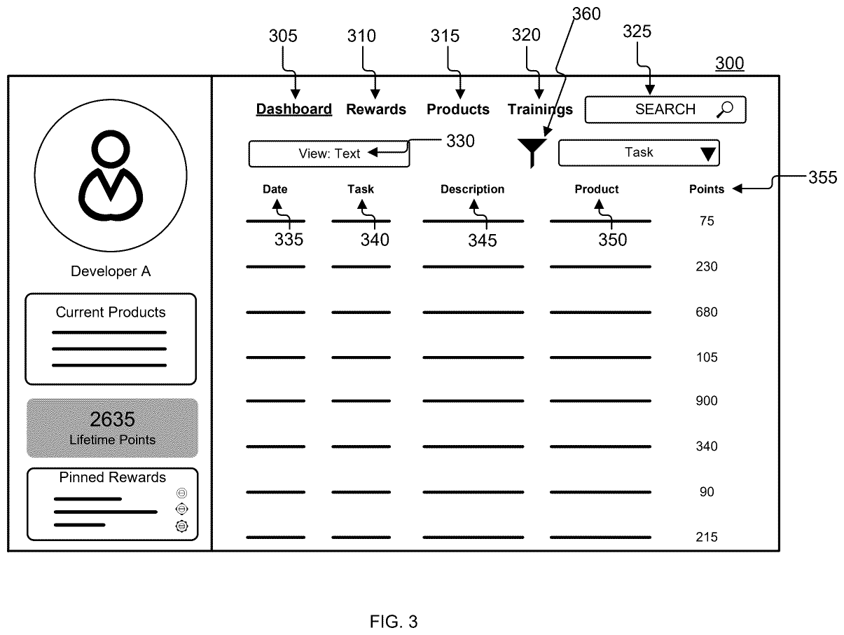

Referring now to FIG. 3, a developer profile interface of a gamification system, according to some embodiments of the present disclosure, is illustrated. In some embodiments, a developer profile interface may be configured to receive information from a risk assessment platform, wherein the risk assessment platform may evaluate a developer work product. In some implementations, the data received by the risk assessment platform may be assigned to a developer profile, wherein the developer profile may include a developer profile interface 300 that may be interacted with. In some embodiments, the developer profile interface 300 may include a menu. In some embodiments, the menu include a dashboard tab 305, a rewards tab 310, a products tab 315, a trainings tab 320, and a search feature 325, wherein clicking a tab on the menu may be configured to direct a user to a separate page, wherein different information may be displayed.

In some aspects, the dashboard tab 305 may include at least one view of the developer profile, wherein the dashboard tab may provide an overview of the developer's status. In some embodiments, a text view 330 of the developer's profile may include information on a specific task. As a way of example and not limitation, the text view 330 of the specific task may include the date 335, task name 340, the task description 345, product the task may be associated with 350, and the digital points awarded 355, as non-limiting examples. In some implementations, the text view 330 may include a plurality of specific tasks, wherein the dashboard tab 305 may be configured to allow a user to track their task history and their digital points accumulated over time.

In some embodiments, the developer profile interface may include a filter feature 360. In some aspects, the filter feature 360 may be configured to allow a user to organize or make viewable at least some of the data retrieved from the risk assessment platform. As a way of example and not limitation, the filter feature 360 may be configured to allow a user to filter the information on the dashboard tab 305 by task name, number of digital points, and date. In some aspects, the filter feature 360 may allow a user to select multiple filters, wherein the dashboard tab 305 may be configured to display the data according to the filters selected.

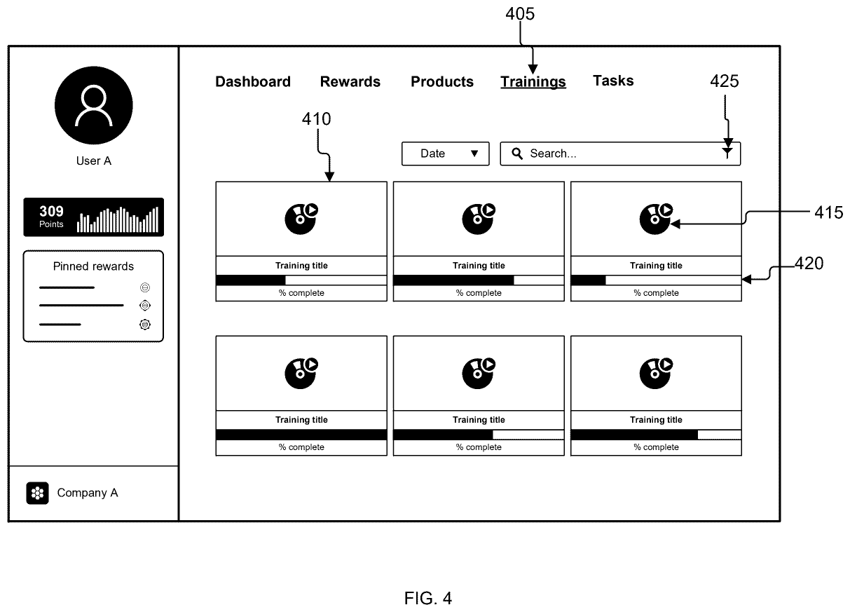

Referring now to FIG. 4, a developer profile interface of a gamification system, according to some embodiments of the present disclosure, is illustrated. In some embodiments, a developer profile may be configured to receive information from a risk assessment platform, wherein the risk assessment platform may evaluate a developer work product. In some implementations, the developer profile may include a trainings tab 405. In some aspects, the trainings tab 405 may include at least one training course 410, wherein a developer may track at least one training course 410 they may have started or completed on the cloud-based application.

In some implementations, the trainings tab 405 may include data on the date, module 415, description, progress 420, and digital points earned from a developer's progress in the at least one training course 410. In some implementations, the progress of the at least one training course 410 may displayed by a percentage or a bar graph, as non-limiting examples. In some embodiments, a user may use a filter feature 425 to organize the display of the trainings tab 405 by task name, number of digital points, progress achieved, and date, as non-limiting examples. In some aspects, the trainings tab may include all of the at least one trainings course 410 the developer may have started or completed. In some implementations, the trainings tab 405 may be configured to recommend or assign at least one training course 410 to a developer based on the results of the risk assessment platform. In some aspects, the at least one training course 410 may be configured to demonstrate efficacy, wherein the user's improved ability in avoiding a previously exposed risk or vulnerability.

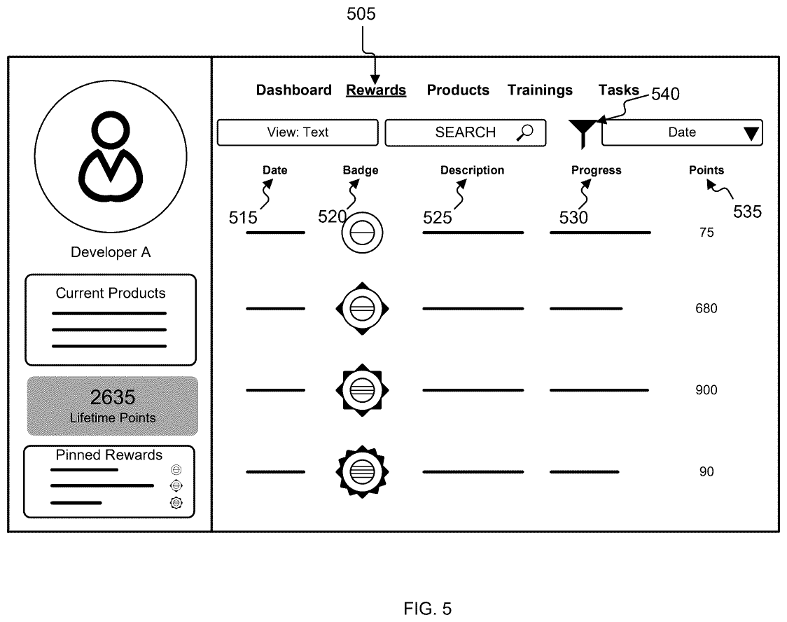

Referring now to FIG. 5, a developer profile interface of a gamification system, according to some embodiments of the present disclosure, is illustrated. In some embodiments, the developer's profile may include a rewards tab 505. In some aspects, the rewards tab may be configured to display the badges and achievements earned by a developer throughout their interaction with the risk assessment platform. In some embodiments, the badges and achievements may be rewarded based on the number of digital points assigned by the risk assessment platform.

In some implementations, the rewards tab may include the date 515, the badge display 520, the description of the badge 525, the progress towards the badge 530, and the digital points required for the badge 535, as non-limiting examples. In some embodiments, the badges and achievements may be earned through reaching predetermined threshold amounts of digital points. In some aspects, the badges and achievements may be earned through means outside of reaching predetermined threshold amounts. As way of example and not limitation, these means may include completing a predetermined threshold amount of training courses, completing a predetermined threshold amount of tasks, interacting with a predetermined threshold amount of developers, and using the risk assessment platform for predetermined threshold amounts of time.

In some embodiments, a profile may include a badge progress tracker. In some aspects, the badge progress tracker may include at least one badge progress display, wherein a developer, team, or organization may track the progress toward at least one badge. In some implementations, the progress may be displayed on a bar, wherein the bar may include a percentage tracker toward the at least one badge. In some aspects, a developer, team, or organization may filter the badge progress tracker based on digital points, percentage, or time, as non-limiting example.

In some embodiments, the developer profile interface 500 may include a rewarded badge display. In some aspects, the reward badge display may be configured to display the badges that a developer earned through their use of the risk assessment platform. In some implementations, when at least one badge progress display may be completed, a developer may be awarded at least one badge that may be displayed on the reward badge display. In some aspects, the reward badge display may include details of the badge, including how the badge was acquired and when the badge was acquired, as non-limiting examples. In some embodiments, the reward badge display may include a filter 540, wherein a developer, team, or organization may filter the reward badge display based on date, type of badge, and difficulty of badge, as non-limiting examples.

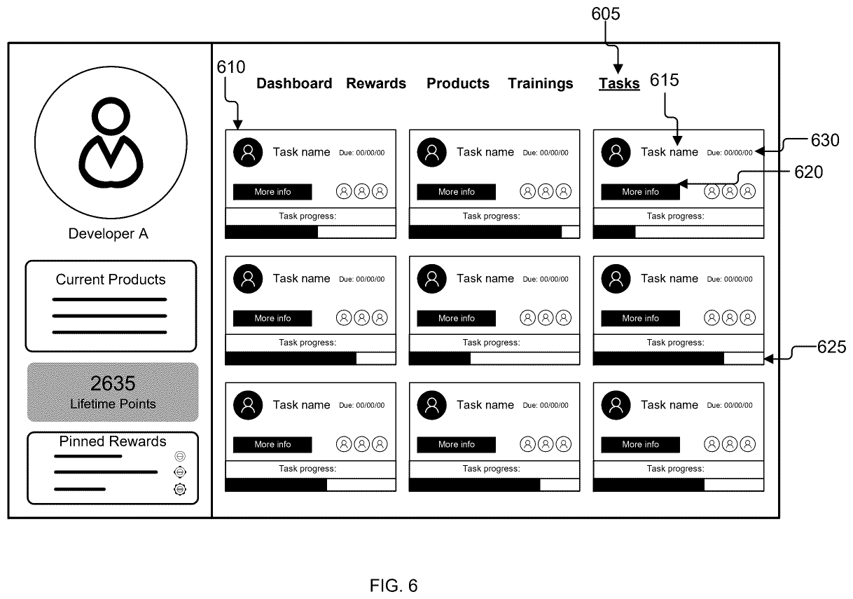

Referring now to FIG. 6, a developer profile interface of a gamification system, according to some embodiments of the present disclosure, is illustrated. In some embodiments, the developer's profile may include a tasks tab 605. In some aspects, the tasks tab 605 may be configured to display at least one completable task 610. In some implementations, the at least one completable task 610 may include a task name 615, a task description 620, a task progress bar 625, a due date 630, and a digital point reward. In some aspects, the at least one completable task 610 may be selected or assigned to a developer, wherein the at least one completable task 610 may be configured to appear on the tasks tab 605. In some implementations, the task tab 605 may be configured to assign or recommend at least one completable task 610 based on vulnerabilities identified in developer's use of the risk assessment platform. In some embodiments, the tasks tab 605 may include the task progress bar 625, wherein the task progress bar 625 may be configured to display how much of a specific task may be completed. In some embodiments, the digital points may be assigned to a developer profile upon completion of the at least one completable task 610.

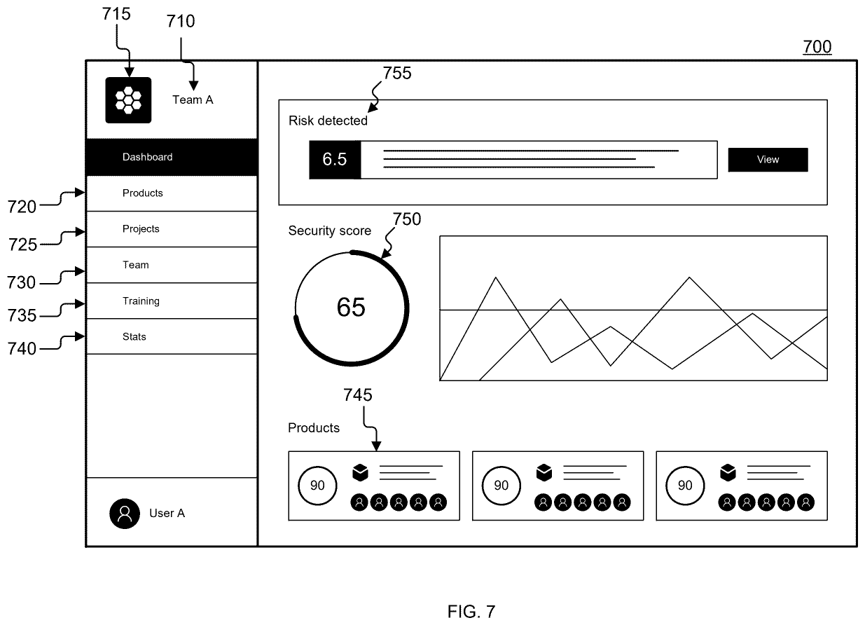

Referring now to FIG. 7, a team profile interface of a gamification system, according to some embodiments of the present disclosure, is illustrated. In some aspects, a team profile may be configured to organize data and communications between at least two developer profiles. In some implementations, the team profile interface 700 may be configured to display data received by the at least two developer profiles. In some embodiments, the team profile may include a team profile interface 700. In some aspects, the team profile interface 700 may display a team name 710, a team profile image 715, products 720, projects 725, teams 730, training 735, statistics 740 and rewards and badges received by the team, as non-limiting examples.

In some implementations, the data may be configured to show the start date or the completion date of at least one task. In some embodiments, the dashboard may be configured to list or display team product 745 and task progress, wherein the digital points assigned based on interaction with the risk assessment platform may be displayed on the dashboard. In some aspects, the team profile may provide a leaderboard for its developers, wherein the leaderboard may organize a list of developers by the number of digital points they acquired. In some embodiments, the team profile interface 700 may include a security score 750, wherein the security score 750 may provide an overall rating of the team. In some aspects, the team profile interface 700 may include a risk detected display 755, wherein the risk detected display may track vulnerabilities discovered by the risk assessment platform.

By way of example and not limitation, the list of developers organize by the number of digital points may be further organized by certain time periods in which certain digital points may have been assigned or certain tasks may have been completed. In some aspects, at least one developer or organization may be the at least one administrator of the team profile, wherein the at least one administrator may have control over who may enter the team profile, what the name of the team profile may be, and what the team profile image may be, as non-limiting examples. In some embodiments, the at least one administrator may create team goals, tasks, objectives, and their own graphical charts using the data retrieved by the risk assessment platform, wherein the graphical charts may be modified to compare different types of data, times, measurement types, and features, as non-limiting examples.

In some implementations, the team profile interface may include a graphical display 755. In some embodiments, the graphical display 755 may include a team member's name, their role, the product they are assigned to, how many risks they were assigned, how many risk they have solved, and their total digital point contribution to the team, as a non-limiting example. In some aspects, the graphical display 755 may rank team members based on their overall digital point contribution. In some implementations, developers may be able to access the team profile interface 700 for teams they are team members on. In some aspects, developers may be able to track their progress to a team, communicate with team members, and see how they are performing relative to other team members using the team profile, as non-limiting examples.

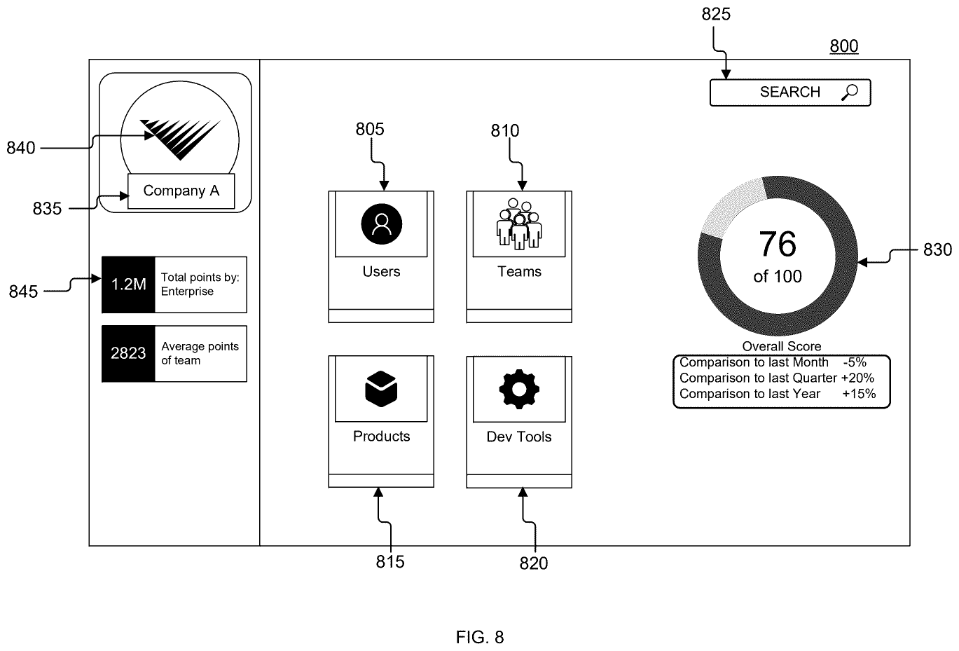

Referring now to FIG. 8, an enterprise profile interface of a gamification system, according to some embodiments of the present disclosure, is illustrated. In some embodiments an enterprise profile may host a combination of developers and teams, wherein the enterprise profile may include an enterprise profile interface 800. In some implementations, the enterprise profile may include a users tab 805, a teams tab 810, a products tab 815, and a development tools tab 820, and a search bar 825, wherein clicking a tab may be configured to direct a user to a separate page, wherein different information may be displayed. In some aspects, the enterprise profile interface 800 may display an overall score 830, an enterprise name 835, an enterprise profile picture 840, and the total amount of digital points assigned to the enterprise 845.

In some embodiments, the users tab 805 may be configured to provide a list of all developers associated with the enterprise that have a developer profile. In some aspects, the teams tab 810 may include a list or information on the different teams connected with the enterprise that may have a team profile. In some implementations, the products tab 815 may direct a user to the different products an enterprise may be working on. In some aspects, the development tools tab 820 may be configured to allow a developer, team, or enterprise to select, download, activate, or deactivate at least one development tool. In some embodiments, the search bar 825 may be configured to allow a user to search the risk assessment platform, wherein the search bar may provide results based on the information typed in the search bar 825.

In some implementations, an enterprise profile interface 800 may include all of their employees, wherein the enterprise may track and evaluate the performance of their employees based on the digital points, achievements, blockchain, non-fungible tokens (NFTs), and badges received. In some aspects, the enterprise profile interface 800 may include the total digital points acquired by the developers of the enterprise 845, projects of an enterprise, badges and achievements earned by an organization, products of an enterprise, percentage of issues solved by an enterprise, team members lists, and graphical charts based on the data received by the risk assessment platform. In some implementations, the enterprise profile may include developers who are associated with the enterprise. In some aspects, the enterprise profile may include data and information from team profiles that may be associated with the enterprise.

In some aspects, the total digital points acquired by the developers of the enterprise 845 may be displayed on the enterprise profile interface 800, wherein enterprises may compare their total digital points earned against one another. In some implementations, the enterprise profile interface 800 may be configured to be customized by the enterprise. By way of example and not limitation, the enterprise may be able to modify the data displayed by graphical charts, the products listed, the projects, enterprise goals, and add or remove developers, as non-limiting examples. In some embodiments, an enterprise profile interface 800 may display which developers or teams may be performing best relative to the risk assessment platform.

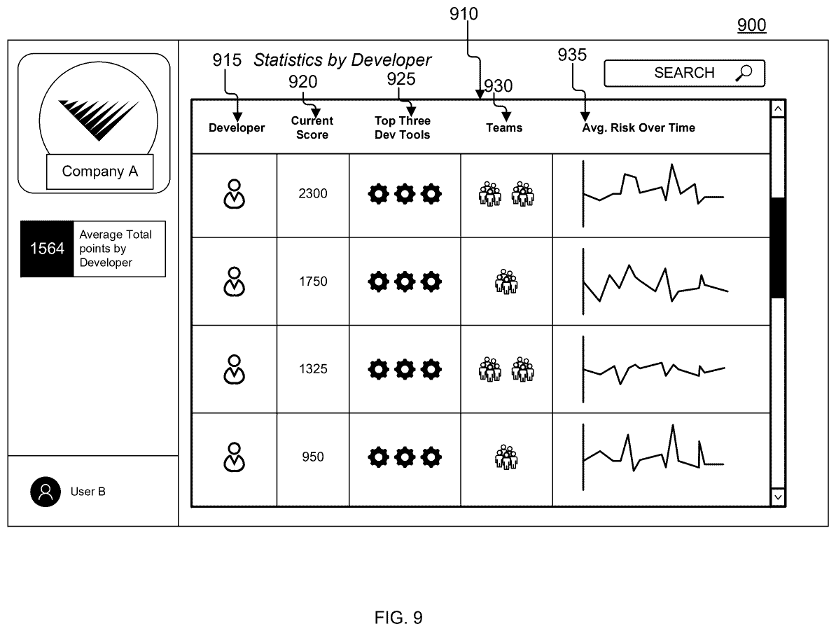

Referring now to FIG. 9, an enterprise profile interface of a gamification system, according to some embodiments of the present disclosure, is illustrated. In some embodiments, the enterprise profile interface 900 may include a page for statistics by developer, wherein the enterprise may track and evaluate the performance of their developers. In some aspects, the statistics by developer page may include a graphical display 910, wherein the graphical display 910 may include the developer name 915, their digital points 920, the developer tools 925 that they use, the teams 930 that they are a part of, and their average risk over time 935. In some implementations, the graphical display 910 may be configured to rank developers by their score or their average risk over time 935, as non-limiting examples, wherein a user may change their view of the graphical display 910.

In some aspects, the developer tools 925 may include the top development tools 925 that a developer utilizes when working towards certain tasks or projects, wherein the graphical display 900 may be configured to show the top three development tools 925 utilized by the developer. In some implementations, the top three developer tools 925 may indicate to the enterprise which developer 925 tools may be most beneficial for different types of tasks and projects.

The average risk over time 935 graphs may indicate the general risk level associated with the developer work product by developer. A developer that may have random, small spikes may not be a concern, whereas a developer that constantly spikes may require more training, management, and oversight. This view may allow for a manager or executive to quickly monitor the vulnerabilities and risks associated with developers.

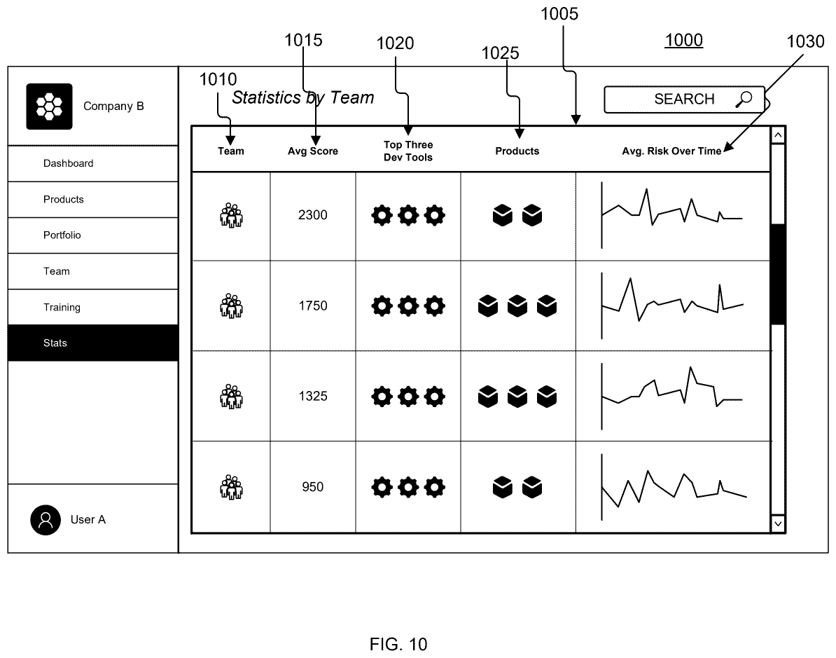

Referring now to FIG. 10, an enterprise profile interface 1000 of a gamification system, according to some embodiments of the present disclosure, is illustrated. In some embodiments, the enterprise profile interface 1000 may include a page for statistics by team, wherein the enterprise may track and evaluate the performance of their teams. In some aspects, the statistics by team page may include a graphical display 1005, wherein the graphical display 1005 may include the team name 1010, their digital points 1015, the development tools 1020 that they use, the products 1025 that they are working towards, and their average risk over time 1030. In some implementations, the graphical display 1005 may be configured to rank teams by their score or their average risk over time 1030, as non-limiting examples, wherein a user may change their view of the graphical display.

In some aspects, the development tools 1020 may include the top development tools 1020 that a team utilizes when working towards certain tasks or projects, wherein the graphical display 1005 may be configured to show the top three development tools 1020 utilized by the team. In some implementations, the top three developments tools 1020 may indicate to the enterprise which development tools 1020 may be most beneficial for different types of tasks and projects. In some aspects, the average risk over time 1030 may indicate whether the combined developer work product of a team has improved over time. In some implementations, the statistics by team page may configured to show what products a team has worked on.

Similarly to the developer risk over time as illustrated in FIG. 9, tracking team risk over time 1030 may allow for insight into how the team operates. In some aspects, the interfaces may be used for further insight. For example, if a team frequently spikes in risk or vulnerability, a manager may want to inspect the individual tracking of risk to determine whether an individual developer may need additional training or may need to be removed from the team. A team member that rarely spikes may need to have more work load or a promotion within the team, as their contribution may positively impact the team.

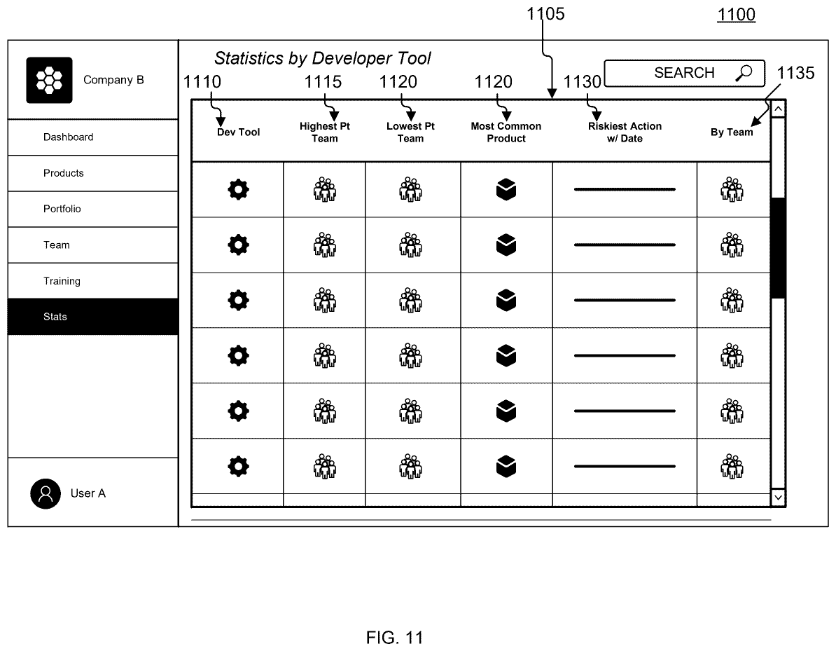

Referring now to FIG. 11, an enterprise profile interface of a gamification system, according to some embodiments of the present disclosure, is illustrated. In some embodiments the enterprise profile interface 1100 may include a statistics by developer tool page, wherein the statistics by developer tool page may be configured to show at least some data associated with development tools. In some aspects, the statistics by developer tool page may include a list or graphic display 1105 that includes information on at least one development tool 1110, wherein a development tool name, a highest point team 1115, a lowest point team 1120, a most common product 1125, a riskiest action 1130, and a by team information 1135 may be displayed, as non-limiting examples.

In some embodiments, the highest point team 1115 may include the team name of the team that was assigned the most digital points while using the at least one development tool 1110. In some aspects, the lower point team 1120 may include the team name of the team that was assigned the least digital points while using the at least one development tool 1110. In some implementations, the most common product 1125 may include the product that may be used most with the at least one development tool 1110. In some aspects, the riskiest action 1130 may include a date, wherein the riskiest action 1130 may be used to indicate when at least one highest risk action 1130 may be taken with the at least one development tool 1110.

Tracking the usage of developer tools 1110 may allow for insight into how the developer tool 1110 is used and whether it adds or subtracts from the vulnerabilities associated with a product 1120 or team 1115, 1120. For example, the riskiest action 1130 may not be a concern if it is easily and quickly resolved once identified by the risk assessment platform. As another example, the riskiest action 1130 may be highly impactful if it had long-term effects or caused a lengthy vulnerability that was difficult to resolve.

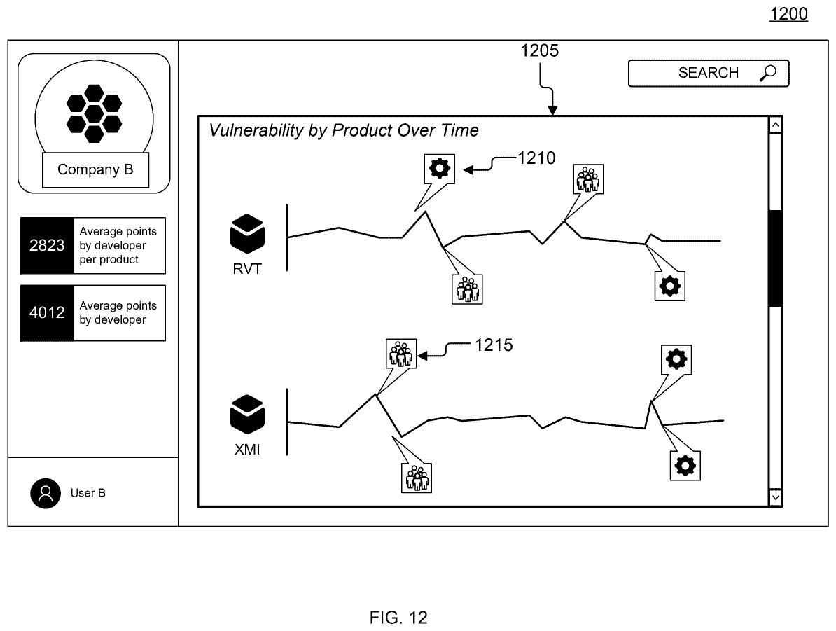

Referring now to FIG. 12, an enterprise profile interface of a gamification system, according to some embodiments of the present disclosure, is illustrated. In some embodiments, the enterprise profile interface 1200 may include at least one graphical display 1205, wherein the at least one graphical display 1205 may include vulnerability by product over time. In some aspects, vulnerability by product over time may be configured to show an increase or decrease of the amount of identified vulnerabilities by the risk assessment platform over at least one period of time. In some implementations, the vulnerability by product over time may be configured to indicate when a vulnerability 1210 may be identified and when a team resolved 1215 the vulnerability 1210. In some aspects, an enterprise may track the performance of their team and the completion of a product based on the at least one graphical display 1205.

In some embodiments, spikes or decreases in vulnerabilities may be identified as primarily caused by a team 1215 or caused by a developer tool 1210. For example, a developer tool 1210 may decay over time and cause a spike in vulnerability that a team 1215 may need to resolve. As another example, a team 1215 with sloppy developer work product may cause a spike in vulnerability that a developer tool 1210 may be able to adjust for.

Referring now to FIG. 13, a profile transfer of a gamification system, according to some embodiments of the present disclosure, is illustrated. In some embodiments, the cloud-based application of the gamification system may be configured to transfer developer profiles from one enterprise profile to another. In some implementations, a developer of enterprise A 1305 may transfer their profile to enterprise B 1310, wherein risk assessment data, point progression data, non-fungible tokens (NFTs) and overall performance rating may be transferred with the developer of enterprise A 1305 to enterprise B 1310, wherein the exact activities that cause spikes or dips in risk assessment may be redacted for confidentiality. In some embodiments, the developer of enterprise A 1305 may transfer to enterprise B 1310, wherein they may transfer to enterprise C 1315 at a later data, wherein their profile data may be further transferred to enterprise C 1315.

In some aspects, the data received by a developer's use of the risk assessment platform may be stored within the developer's profile. In some aspects, a developer may desire to transfer the digital points, rewards, badges, achievements, blockchain, non-fungible tokens (NFTs), and progress data from one enterprise to another. In some implementations, a developer may use their digital points, rewards, badges, achievements, blockchain, non-fungible tokens (NFTs), and progress data when leveraging themselves in a professional environment, as non-limiting examples. In some aspects, a developer profile may be deactivated, wherein a developer profile may remain viewable on the risk assessment profile without any additional vulnerability data being received by the developer profile. In some implementations, the deactivated developer profile may be reactivated, wherein it may continue its progression from where it started, wherein its total digital points, badges, and achievements remains the same.

In some embodiments, a developer's profile may exist separately from an enterprise, wherein a developer may leave an enterprise voluntarily or join an enterprise with approval from the new enterprise. In some aspects, the data assigned to a developer's profile may stay with that profile when moving to a new enterprise, wherein the developer's individual rewards, achievements, and digital points, as non-limiting examples, may be included in the enterprise profile. In some aspects, the developer's profile may continue to progress using the risk assessment platform, wherein their digital points, rewards, blockchain, non-fungible tokens (NFTs), and badges, as non-limiting examples, may continue from where they were at while the developer was associated with the previous organization.

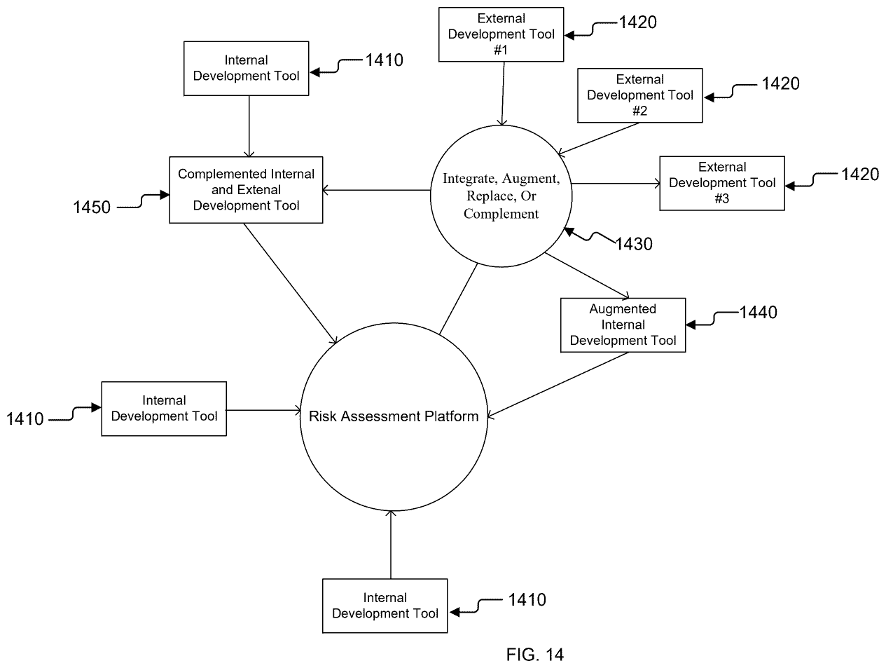

Referring now to FIG. 14, a method for the implementation of development tools of a gamification system, according to some embodiments of the present disclosure, is illustrated. At 1410, at least one internal development tool may be utilized by the risk assessment platform, wherein the at least one internal development tool may be built into the risk assessment platform. In some embodiments, at 1420, at least one external development tools may be accessed from at least one third-party source. In some aspects, at 1430, the risk assessment platform may be configured to integrate, augment, replace, or complement at least one external development tool.

In some implementations, at 1440, an augmented internal development tool may be implemented into the risk assessment platform, wherein the augmented internal development tool may have been changed through interaction with at least one external development tool. In some implementations, at 1450, at least one complemented internal and external development tool may be implemented into the risk assessment platform, wherein at least one external development tool and at least one internal development tool may be utilized alongside one another to benefit a developer work product. In some embodiments, the at least one external development tool may replace at least one internal development tool, wherein the functions of the at least one external development tool and the at least one internal development tool may overlap removing the desire to have both of the development tools.

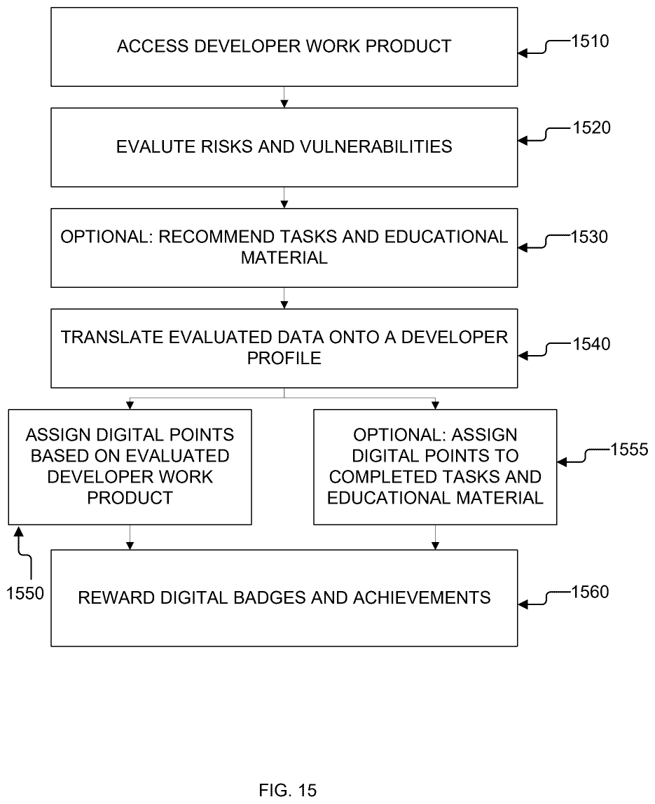

Referring now to FIG. 15, a method for a gamification system of cybersecurity, according to some embodiments of the present disclosure, is illustrated. At 1510, the risk assessment platform may access the developer work product. At 1520, the risk assessment platform may evaluate the risks and vulnerabilities of the development work product. In some embodiments, at 1530, the risk assessment platform may recommend tasks and educational material to a developer based on the evaluated developer work product.

At 1540, the data acquired by the risk assessment platform may be translated and evaluated onto a developer profile. At 1550, the risk assessment platform may assign digital points based on evaluated developer work product. In some implementations, at 1555, the risk assessment platform may assign digital points based on completed tasks and educational material. At 1560, the risk assessment platform may reward digital badges, blockchain, non-fungible tokens (NFTs), and achievements.

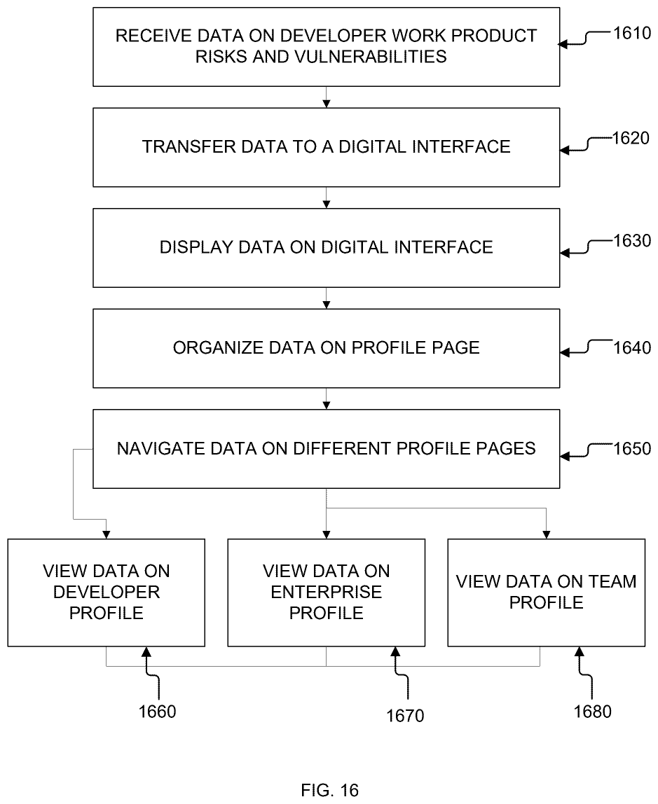

Referring now to FIG. 16, a method for a graphical user interface for a gamification system of cybersecurity, according to some embodiments of the present disclosure, is illustrated. At 1610, the cloud-based application may received data on the risks and vulnerabilities received from the risk assessment platform. At 1620, the cloud-based application may transfer the data to a digital interface. At 1630, the cloud-based platform may display the data onto a digital interface. At 1640, the cloud-based platform may organize the data onto a profile page. At 1650, a user may navigate the data on different profile pages. At 1660, 1670, and 1680, a user may navigate between a developer profile, an enterprise profile, and a team profile, respectively.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

The previous description and drawings are illustrative and are not to be construed as limiting. Numerous specific details are described to provide a thorough understanding of the disclosure. In certain instances, well-known or conventional details are not described in order to avoid obscuring the description. References to “one” or “an” embodiment in the present disclosure may be, but is not necessarily, a reference to the same embodiment; and, such references mean at least one of the embodiments. If a component is not shown in a drawing then this provides support for a negative limitation in the claims stating that that component is “not” present. However, the above statement is not limiting and in another embodiment, the missing component can be included in a claimed embodiment.

Reference in this specification to “one embodiment,” “an embodiment,” “a preferred embodiment” or any other phrase mentioning the word “embodiment” means that a particular feature, structure, or characteristic described in connection with the embodiment is included in at least one embodiment of the-disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional. Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

In a preferred embodiment of the present invention, functionality is implemented as software executing on a server that is in connection, via a network, with other portions of the system, including databases and external services. The server comprises a computer device capable of receiving input commands, processing data, and outputting the results for the user. Preferably, the server consists of RAM (memory), hard disk, network, central processing unit (CPU). It will be understood and appreciated by those of skill in the art that the server could be replaced with, or augmented by, any number of other computer device types or processing units, including but not limited to a desktop computer, laptop computer, mobile or tablet device, or the like. Similarly, the hard disk could be replaced with any number of computer storage devices, including flash drives, removable media storage devices (CDs, DVDs, etc.), or the like.

The network can consist of any network type, including but not limited to a local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). The various components of the present invention, are stored or recorded on a hard disk or other like storage devices described above, which may be accessed and utilized by a web browser, mobile app, the server (over the network), or any of the peripheral devices described herein. One or more of the modules or steps of the present invention also may be stored or recorded on the server, and transmitted over the network, to be accessed and utilized by a web browser, a mobile app, or any other computing device that may be connected to one or more of the web browser, mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present invention could be accomplished with standard programming techniques with logic to accomplish the various steps of the present invention described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C #, Java, Cobol, assembler, PERL, Python, PHP, or the like, or macros using Excel or other similar or related applications with various algorithms being implemented with any combination of data structures, objects, processes, routines or other programming elements.

1. A system for gamifying cybersecurity comprising:
a risk assessment platform configured to:
receive at least a portion of developer work product associated with a developer profile, wherein the portion of developer work product originates from at least a first developer;
evaluate at least a portion of developer work product, wherein evaluating assesses a first vulnerability factor based on whether the at least the portion of the developer work product increases vulnerability or decreases vulnerability of at least a first product;
assign at least one set of digital points distributed as rewards to the developer profile based on the assessment of the first vulnerability factor of the developer's work product; and
recommend tasks or educational material-based on the at least first developer based on the first vulnerability factor for the at least a portion of developer work product, wherein the risk assessment platform assigns additional at least one set of digital points based on the completion of the tasks or educational material.

2. The system for gamifying cybersecurity of claim 1, wherein the risk assessment platform is further configured to prompt the at least the first developer when the assessment determines the at least the portion of developer work product increases vulnerability, wherein the prompt requests a first edit to the at least to portion of developer work product.

3. The system for gamifying cybersecurity of claim 1 further comprising:
a cloud-based platform configured to:
receive data retrieved from the risk assessment platform;
organize received data into a first developer profile, wherein the first developer profile is assigned to at least one developer originating the developer work product;
display the at least one set of digital points assigned to a developer profile on a graphical interface;
reward badges and achievements based on the at least one set of digital points, wherein the badges and achievements are displayed on the developer profile.

4. The system of gamifying cybersecurity of claim 2, further comprising a social media infrastructure comprising:
a developer profile;
an organization profile that includes a plurality of developers that work at the same company;
a team profile that includes a plurality of developers;
a menu interface, wherein at least one party may navigate between the different profiles on the social media infrastructure.

5. The system of gamifying cybersecurity of claim 1, further comprising:
a developer profile comprising at least a set of digital points based on at least a portion of developer work product assessed for vulnerability;
a points tracking mechanism to at least partially determine a level of expertise in cybersecurity based on predefined scoring metrics.

6. The system for gamifying cybersecurity of claim 1, wherein the risk assessment platform includes developer tools to assist developer work product.

7. The system for gamifying cybersecurity of claim 5, wherein the developer tools of the risk assessment platform integrates, augments, replaces, or compliments third-party developer tools used by the at least first developer.

8. The system of gamifying cybersecurity of claim 6, wherein the developer tools are enabled or disabled through the cloud-based platform.

9. The system for gamifying cybersecurity of claim 1, wherein the risk assessment platform and cloud-based platform include at least one artificial intelligence infrastructure.

10. The system of gamifying cybersecurity of claim 9, wherein the at least one artificial intelligence infrastructure provides recommendations on code or programming decisions, tasks, and educational materials.

11. The system of gamifying cybersecurity of claim 1, wherein the graphical interface of the cloud-based platform includes an organization profile or team profile, configured to display collective digital points and vulnerabilities.

12. The system of gamifying cybersecurity of claim 1, wherein the digital points assigned to the at the first developer are tracked in the cloud-based application, wherein an enterprise, a team, and a developer earn rewards and badges for reaching predetermined threshold values.

13. The system of gamifying cybersecurity of claim 12, wherein a graphical display is included on the cloud-based application that tracks and displays the progress an enterprise, a team, and a developer's progress towards the predetermined threshold values to be rewarded a badge or achievement.

14. The system of gamifying cybersecurity of claim 2, wherein the cloud-based platform includes educational courses based on the evaluation of the at least a portion of the developer work product, wherein the cloud-based platform rewards at least one set of digital points to a developer profile for the completion of at least one educational course.

15. The system of gamifying cybersecurity of claim 14, wherein the cloud-based platform is configured to recommend at least one educational course based on the developer work product.

16. A method for a risk assessment platform for gamifying cybersecurity comprising:
accessing at least a portion of developer work product;
evaluating the at least a portion of developer work product for risks and vulnerabilities in real time;
translating the at least a portion of evaluated developer work product onto a developer profile;
assigning digital points based on the at least a portion of evaluated developer work product and the completion of tasks and educational material;
rewarding digital badges and achievements based on the assigned digital points.

17. The method of claim 16, wherein the method further comprises:
receiving vulnerability data on developer work product;
transferring vulnerability data to a digital interface;
displaying vulnerability data on the digital interface; and
organizing vulnerability data on at least one profile page.

18. The method of claim 16, wherein the risk assessment platform recommends tasks and educational material based on the evaluated risks and vulnerabilities.

19. The method of claim 16, wherein the risk assessment platform includes at least one developer tool.

20. The method of claim 18, wherein the risk assessment platform assigns digital points to completed based on completed tasks and educational materials.
